(19) United States
(12) Patent Application Publication
(10) Pub. No.: US 2007/0169157 A1
(43) Pub. Date: Jul. 19, 2007

(54) Computer controlled display implementation for displaying ancillary content during interruption of the primary display content

(76) Inventors: Michael N. Abernethy, Pflugerville, TX (US); Kulvir Singh Bhogal, Fort Worth, TX (US); Travis M. Grigsby, Austin, TX (US); Robert Norris-Lance Krentler, Austin, TX (US); Alexandre Polozoff, Bloomington, IL (US)

Correspondence Address: IBM CORPORATION;INTELLECTUAL PROPERTY LAW, 11400 BURNET ROAD, AUSTIN, TX, 78758, US

(21) Appl. No.: 11/335,452

(22) Filed: Jan. 19, 2006

(51) Int. Cl. H04N 7/173; H04N 5/445; H04N 7/16

(52) U.S. Cl. 725/89; 725/135; 348/563; 348/564; 725/88; 725/102

(57) ABSTRACT

A computer controlled display system for displaying selected primary visual content to a viewer, and provides a system for displaying content ancillary to the primary visual content to the viewer which comprises enabling a viewer to display selected primary visual content having implementation for interrupting the display of the primary visual content. In response to such an interruption, there is provided an implementation which is independent of the means for interrupting for displaying the ancillary visual content to said viewer during the time period of said interruption. The interrupting may be interactively commenced by the viewer, or the interrupt may be automatically commenced by the system.

### TECHNICAL FIELD

The present invention relates to computer controlled displays including television displays, and particularly the handling of interrupts of displayed content as may be applied to television displays controlled through Digital Video Recorders (DVRs).

### BACKGROUND OF RELATED ART

The past decade has been marked by a technological revolution driven by the convergence of the data processing industry with the consumer electronics industry. An area where this relationship has been advantageous is that of digital video recording. This has resulted in the emergence of a set top box based upon the PVR, also marketed as DVRs. A description of the PVR and like digital video recorders and their increasing consumer functions as computer controlled “engines” in television set top boxes may be found in: IEEE Spectrum periodical, (IEEE Inc.), New York, N.Y., July 2002, at pp. 26-31. The DVR has many advantages, particularly ease of use to the users in the advance scheduling of television programs to be subsequently sequentially recorded. However, extensive usage of the DVR has also given rise to a set of problems involving the viewer, the broadcasting organizations which broadcast the television programs, the sponsors or hosts of the commercial content which is of course embedded in such television programs.

The background of this television industry should be briefly reviewed in order to better understand the problems and issues. When, television was first introduced for mass media entertainment and education, the television program content was broadcast essentially line of sight antenna to antenna. The content was of course supported and paid for by commercial sponsors or hosts who paid for or created the content in order to have opportunities to interleave or embed periodic commercial content into the television program. This was the return benefit which the sponsor or host received for his support of the television program. As the demand for television programming rapidly increased, traditional line of sight antenna broadcasting had to be supplemented and replaced to a very great extent by cable and satellite services. The frequency channels that the Government made available for the presentation of programming by respective television stations also rapidly increased. This led to television service providers that obtained and consolidated the programs transmitted by the respective television stations to be presented to viewers via government designated frequency channels. The original television stations would transmit at their assigned frequencies either by direct line of sight, cable or through satellites. The television service providers then received the respective program channel signals and consolidated all the data in such transmissions into an integrated data stream representative of an extensive set of television programs being presented on corresponding channels into an unitary data stream that was then compressed and transmitted to the television service provider's subscribers either via satellite or cable. This integrated data stream was encrypted to protect the provider's revenues. The viewer could then receive this integrated data stream and extract any “live” or real-time television program through his television receiver or frequency channel tuner. The provider system would extract the appropriate television program data directly from the real-time satellite or cable service provider integrated data stream. The extracted program data would be decrypted and decompressed and the television program would be displayed on a real-time basis on the television set display.

Where the user wished to record a particular television program for future viewing, it would be extracted at its scheduled viewing period from the integrated data stream in the same manner as described, decrypted, decompressed and recorded on disk drives (DVD). Individual programs on their respective channels could still be recorded on a real-time basis by first extracting, decrypting and decompressing.

This, of course, resulted in the current state of the DVR or PVR industry where the user, with an appropriate DVR, could record dozens of broadcast and transmitted television programs for future viewing merely by entering its unique identifier. Despite all of the described advances in the presentation of television programming to the viewers, the state of the industry is such that television programs are still to a large part produced for the television sponsors or hosts who still interleave commercial content into the broadcast television programs. In addition, greater and greater numbers of viewers are viewing their television programming from their personal recordings.

Because viewers, and particularly viewers who record their television programs are pressed for time, and commercial content in television program may often approach 25% of the total content, the motivation is very strong for viewers to skip through i.e. pass over the commercial content of the program. Even the ability to skip through commercial content has evolved from the “fast forward” function on the early video recorders to present DVR functions which involve sensing the beginning and end of the commercial content and automatically passing over the commercial content. Because of the substantial contribution which sponsor/host resources have made to television programming, there has been an increasing concern in the whole industry that this capability to eliminate commercial content may very adversely affect the whole industry. These concerns have caused and threatened copyright litigation and Federal legislation to mitigate the problem.

### SUMMARY OF THE PRESENT INVENTION

The present invention offers an implementation which mitigate some of the concerns of the commercial hosts without unduly inconveniencing the viewer who is pressed for time and chooses to pass over commercial content. While the present invention is specifically applicable to the problems of television commercial skipping, it has broader applicability in dealing with interruptions in the display of any selected displayed visual content in any computer controlled display system.

In its broadest aspects, the invention relates to a computer controlled display system for displaying selected primary visual content to a viewer, and provides a system for displaying content ancillary to the primary visual content to the viewer which comprises means enabling a viewer to display selected primary visual content having means for interrupting the display of the primary visual content. In response to such an interruption, there is provided an implementation, which is independent of the means for interrupting, for displaying the ancillary visual content to said viewer during the time period of the interruption. The interrupting means may be interactively commenced by the viewer, or the interrupt may be automatically commenced by the system. The system may be a network system, and the interrupt may be activated by a download of the primary content from the network.

As set forth hereinabove, the invention may be implemented in a system for recording viewer-selected broadcast television programs and for playing back such recorded television programs at times selected by a viewer comprising means for enabling said viewer to playback a selected recorded television program combined with means enabling the viewer to interactively pass over commercial portions of the recorded television program. The implementation of this invention is responsive to the commercial pass over, and displays content ancillary to the content of the commercial portions during the time period of passing over these commercial portions. The recorded program may be recorded on a DVR. Of course since the original primary commercial content will benefit a host, the ancillary content should also benefit the same host.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of how the system of the present invention is organized around a DVR;

FIG. 2 is a diagrammatic view of a display of a recorded television program on a DVR controlled television display;

FIG. 3 is the same diagrammatic view of FIG. 2 at the instant that a commercial appears on the television display;

FIG. 4 is the same diagrammatic view of FIG. 3 during a standard “fast forward” to pass over the commercial;

FIG. 5 is the same diagrammatic view of FIG. 4 during a standard “fast forward” to pass over the commercial where in accordance with the invention, the ancillary content is displayed;

FIG. 6 is a flowchart describing how the implementation system of the present invention provides for the display of ancillary display content during an interrupt in the display of primary content;

FIG. 7 is a flowchart of an illustrative run of a process set up in FIG. 6;

FIG. 8 is a variation of the illustration screen of FIG. 5 wherein the look of the progress bar itself is determined by the ancillary content to be displayed; and

FIG. 9 is a variation of the illustration screen of FIG. 8 showing another variation in the look of the progress bar.

### DETAILED DESCRIPTION OF THE PREFERRED EMBODIMENT

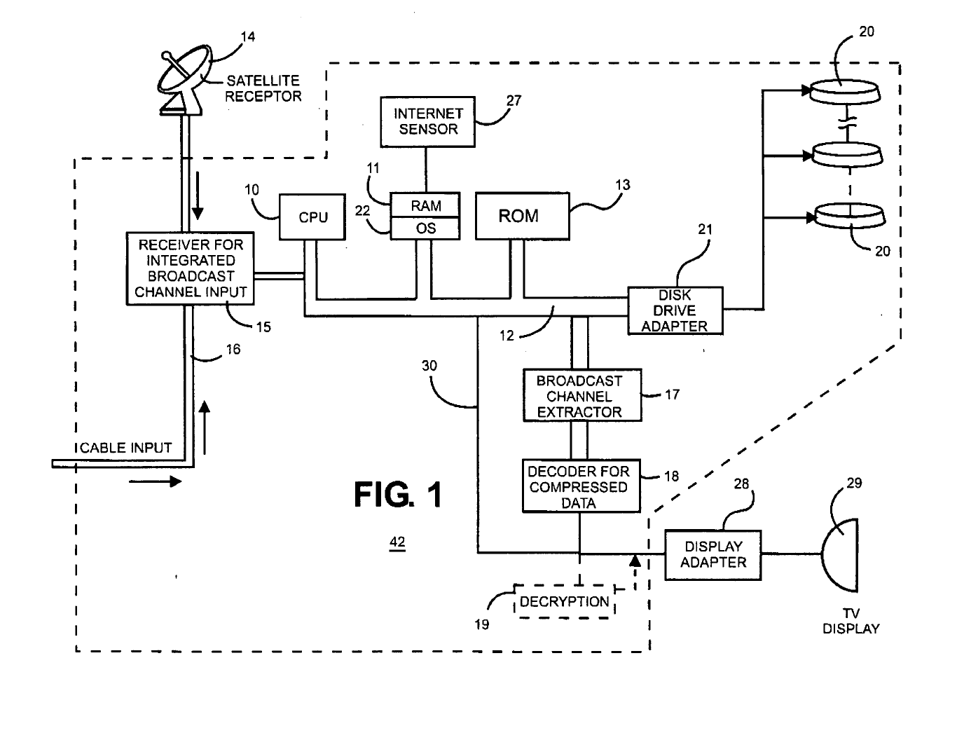

Referring to FIG. 1, there is shown a generalized view of a system of the present invention illustrating the present invention organized around a DVR. This is a generalized example for providing background information relative to DVR system organization. The receiver 15 at the viewer's home receives and integrates input from the satellite provider via satellite receptor 14 or cable input from the cable provider. The viewer's system may also still get line of sight antenna input from the local television broadcasts.

The apparatus shown connected to receiver 15 may be conveniently housed in a television set top box or in some late systems, the whole DVR apparatus may be integrated within a unitary television set. Satellite receptor antenna 14 receives the integrated data stream that is applied to a standard receiver for integrated broadcast channel input 15. Similarly, the integrated data stream from cable may be applied through input 16 to receiver 15.

The operations involved in the present invention are controlled by a data processing system under the control of a central processing unit 10, which, in turn, is interconnected to various other components by system bus 12.

An operating system (OS) 22 that runs on processor 10 provides control and is used to coordinate the functions of the various components of the control system. The OS 22 is stored in Random Access Memory (RAM) 11. The programs for the functions, including those of the present invention may be permanently stored in Read Only Memory (ROM) 13 and moved into and out of RAM to perform their respective functions. In the normal operation for real-time television program playing, the integrated incoming data stream, under CPU control, is applied to broadcast channel extractor 17 that extracts the data representative of the television program scheduled for the channel that the user has selected on a tuner (not shown) and applies the extracted data to decoder 18 where it is decompressed. Also, since the data is likely to be encrypted to commercially protect the provider, encrypted data is optionally put through conventional decryption means 19 and then applied to a conventional television display adapter 28 to be displayed on the user's television set 29.

When the incoming unitary data stream is to be recorded on the DVR, the signal is processed through a disk drive adapter 21 and stored on disk drives 20. In the conventional operation of a DVR, the television program scheduled for a given channel at a given time is be extracted by extractor 17, decompressed on decoder 18, decrypted and then stored on a disk drive 20 provided on the DVR. This individual program would be recorded and, thus, stored on the disk drive either in response to either advance scheduling by the user for such a recording or a user request to record a real-time presented television program.

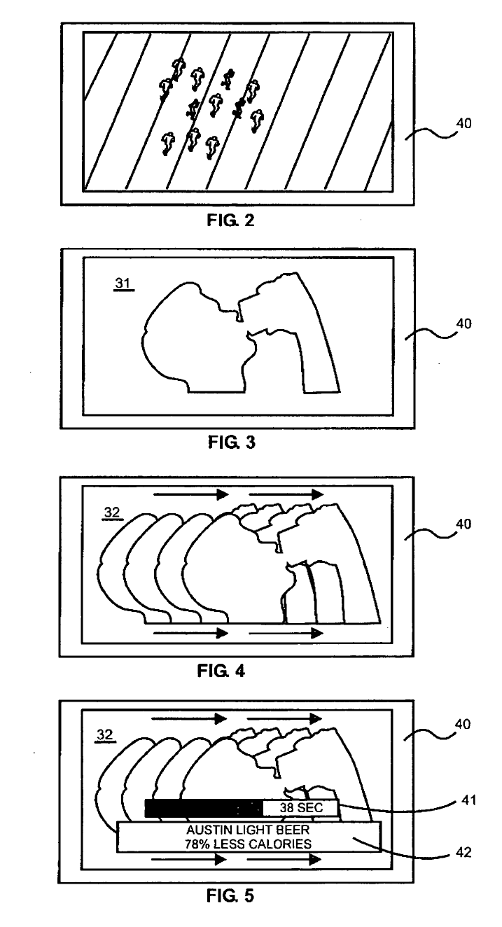

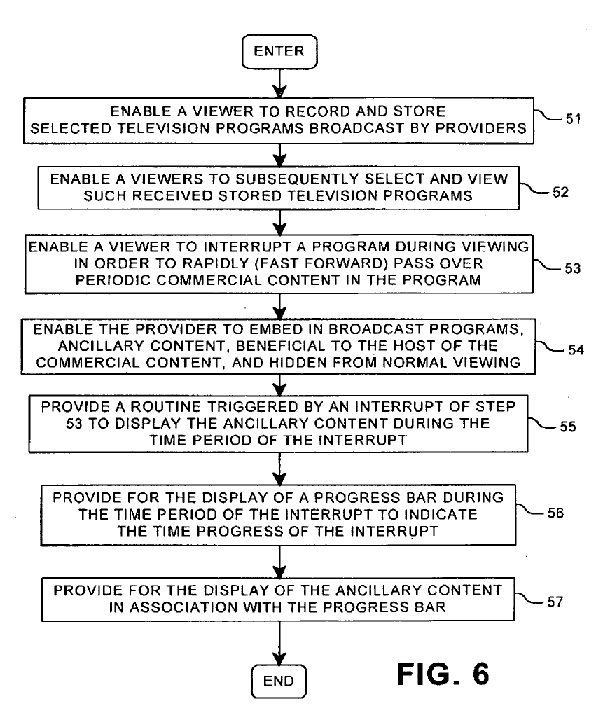

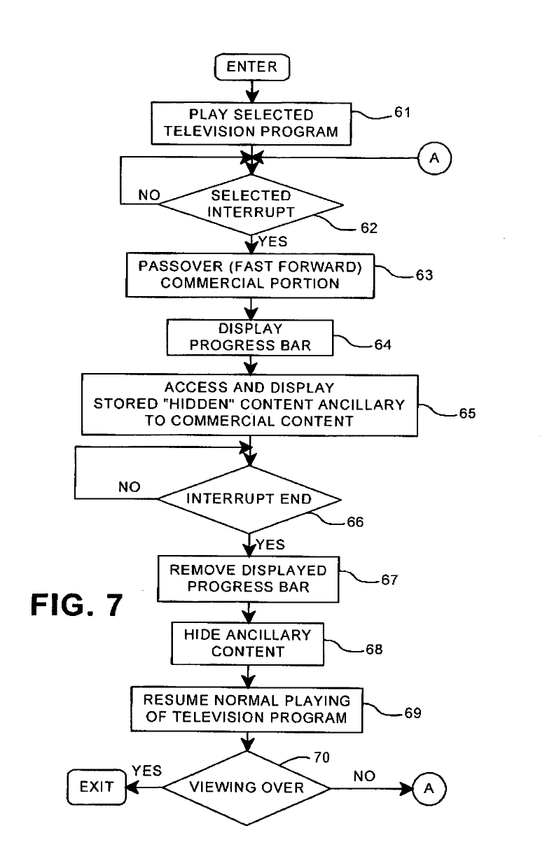

During, playback, the viewer, via the control of OS 22, selects a television program recorded on disk drive 20 which is then applied to display adapter via connector 30 and presented on the TV display 29. The interrupt programming of this invention is stored in RAM 11, and is responsive to input from an interrupt sensor 27. This will be described in greater detail with respect to the illustrative television displays of FIGS. 2-5, and the flow charts of FIGS. 6 and 7.

In the sequence of FIGS. 2-5, in FIG. 2, the viewer is watching program content 30, for example, a recorded football game. Football games are notorious for their very high commercial content. Normally, the commercial 31 would appear in its recorded sequence, FIG. 3. However, the viewer is set up to fast forward 32 through the recorded commercial, FIG. 4. In accordance with the present invention, during this fast forward, the initiation and termination of the fast forward are sensed, and during the time of this fast forward, a window of content 42 ancillary to the commercial content is displayed, FIG. 5. Where, the display has a progress bar 41 of FIG. 5 to indicate the progress of the interrupt, the window of ancillary content 42 may be presented adjacent to the progress bar.

Now, with reference to the programming shown in FIG. 6, there will be described how the system and programs of the present invention are set up. There is a staring implementation wherein the viewer is enabled to record and store selected television programs broadcast by the television program providers, step 51. The viewers are enabled to select and view such recorded television programs as desired, step 52. On DVRs and most television recording devices, the user is enabled to interrupt the presented television program and pass over, e.g. fast forward over commercial content, step 53. The provider of the broadcast television program is enabled to embed into the broadcast content ancillary content which is to the commercial benefit of the sponsor or host of the television program. This content is hidden during normal viewing, step 54. A routine is provided, which is triggered by an interrupt from step 53, to display the normally hidden ancillary content beneficial to the host, step 55. In a preferred embodiment, step 56, there is a progress bar to indicate the length of timing out of the interrupt, and the ancillary content is displayed in association with this progress, step 57.

Now, with reference to the flowchart of FIG. 7, a simplified illustrative run of the process set up in FIG. 6 will be described. Assume that the viewer has selected, and is viewing a recorded television program, step 61. The process is monitored for viewer interrupts, step 62. If No, there is no interrupt, the monitoring continues. If Yes, there is an interrupt, then, step 63, if a passover, e.g., fast forward or rewind (through a commercial portion) is in progress, as indicated by the display of the progress bar, step 64, then the recorded and stored hidden ancillary content in the recorded television program is displayed, step 65, in association with the progress bar as indicated in FIG. 5. A determination is then made as to the end, or the beginning in the case of rewind, of the commercial pass over as triggered by the interrupt, step 66. If No, the interrupt has not ended, then the monitoring for the interrupt end continues. If Yes the interrupt is over, then the progress bar is removed from the display, step 67, and the ancillary commercial content is again hidden, step 68. Then, the normal playing back of the recorded television program is continued, step 69. At this point, a determination may be conveniently made as to whether the viewer's playback is over, step 70. If Yes, the process is exited. If No, the process is returned back to step 62 via branch “A”.

As set forth hereinabove, there are implementations other than the illustrative interrupts in playback of recorded broadcast television program to which the present invention is applicable, e.g. network applications including interrupts for the downloading data content such as films and videos. However, one aspect of the present invention is that while the display of ancillary content is triggered by i.e. responsive to the interrupt means, it is independent of and comes from a function or source independent of the interrupt function.

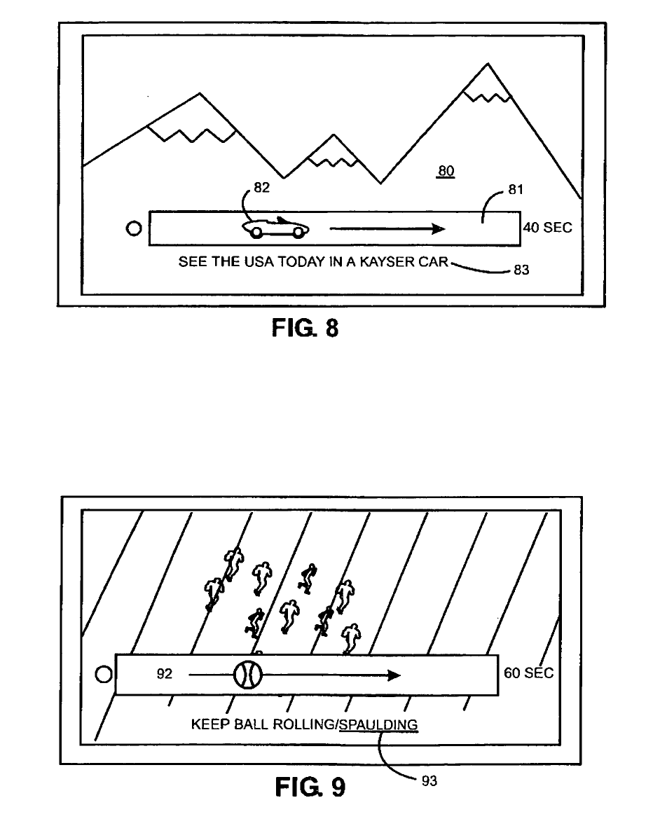

In accordance with a specific application of implementing the display of ancillary commercial content in association with a progress bar as generally shown in FIG. 5, the progress bar itself may have a unique appearance defining its ancillary commercial content. Reference is made to FIG. 8, wherein the content of display screen 80 is interrupted at the beginning of a commercial presentation e.g. for the “Kayser Automobile” in this example. In response to the sensing of fast forward or like interrupt of the commercial, the DVR reads data embedded in the data content of the commercial which defines the look of the progress bar 81, and the look of the progress bar is displayed: a Kayser car 82 moving across the progress bar to indicate elapsed time. This may be accompanied by other display data 83 descriptive of the car.

In a similar example in FIG. 9, the content of display screen 90 is interrupted at the beginning of a commercial presentation e.g. for the “Spaulding Ball Products” in this example. In response to the sensing of fast forward or like interrupt of the commercial, the DVR reads data embedded in the data content of the commercial which defines the look of the progress bar 91, and the look of the progress bar is displayed: a ball 92 moving across the progress bar to indicate elapsed time. This may be accompanied by other display data 93 descriptive of the products.

Although certain preferred embodiments have been shown and described, it will be understood that many changes and modifications may be made therein without departing from the scope and intent of the appended claims.

What is claimed is:

1. In a computer controlled presentation system for presenting selected primary content to a viewer, a system for presenting content ancillary to the primary content to the user comprising:
means enabling a user to present selected primary content;
means for interrupting the presentation of said primary content; and
means, independent of but responsive to said means for interrupting, for presenting said ancillary content to said user during the time period of said interruption.

2. The system for presenting ancillary content of claim 1 wherein said means for interrupting are user interactive means.

3. The system for presenting ancillary content of claim 1 wherein said means for interrupting are automatically activated by system functions.

4. The system for presenting ancillary content of claim 3 wherein:
said system is connected to a network; and
said means for interrupting are activated by a network function.

5. The system for presenting ancillary content of claim 4 wherein:
said means for interrupting are activated by a download of said primary content from the network; and
said ancillary content is related to said primary content being downloaded.

6. A system for recording viewer-selected broadcast television programs and for playing back such recorded television programs by a viewer comprising:
means for enabling said viewer to playback a selected recorded television program;
means enabling said viewer to interactively pass over commercial portions of said recorded television program; and
means, responsive to said commercial pass over means, for displaying content ancillary to the content of said commercial portions during the time period of passing over said commercial portions.

7. The system for recording viewer-selected broadcast television programs of claim 6 wherein said system is a digital video recorder.

8. The digital video recorder system of claim 7 wherein a commercial portion is produced by a content producer, and said ancillary content is produced by either the content producer or an another content producer.

9. The digital video recorder system of claim 7 further including:
means for displaying a progress bar indicating the time duration and progress of said commercial pass over; and
wherein means for displaying said ancillary content is associated with said progress bar.

10. The digital video recorder system of claim 7 further including:
a displayed progress bar, for indicating the time duration of said commercial pass over, having a unique appearance representative of ancillary commercial content

11. The digital video recorder system of claim 10 wherein said unique appearance of said progress bar dynamically changes with the progress of said progress bar.

12. In a computer controlled system for presenting selected primary content to a user, a method for presenting content ancillary to the primary content to the user comprising:
enabling a user to present selected primary content;
interrupting the presentation of said primary content; and
presenting said ancillary content to said user during the time period of said interruption independent of but responsive to said interruption.

13. The method for presenting ancillary content of claim 12 wherein said interrupting is user interactivated.

14. The method for presenting ancillary content of claim 12 wherein said interrupting is activated by a system function.

15. The method for presenting ancillary content of claim 12 wherein:
said system is connected to a network; and
said interrupting is activated by a network function.

16. The method for presenting ancillary content of claim 15 wherein:
said means for interrupting are activated by a download of said primary content from the network; and
said ancillary content is related to said primary content being downloaded.

17. The method for presenting ancillary content of claim 12 wherein:
said presentation is on a television display;
said primary content is a television program broadcasted by a television network;
said primary content is recorded as a stored television program on a digital video recorder, and played back by said viewer;
said viewer is enabled to interactively pass over commercial portions of said television program produced by a content producer; and
said ancillary content is produced by either the content producer or an another content producer

18. The method for presenting ancillary content of claim 17 wherein said ancillary content is displayed in association with a displayed progress bar indicating the time progress of said commercial pass over.

19. A computer program having code recorded on a computer readable medium for presenting content ancillary to the primary content in a computer controlled presentation system for presenting selected primary content to a user comprising:
means enabling a user to present selected primary content;
means for interrupting the presentation of said primary content; and
means, independent of but responsive to said means for interrupting, for presenting said ancillary content to said user during the time period of said interruption.

20. The computer program of claim 19 wherein said display system is connected to a television network
said primary content is a television program broadcast by said network and stored on a digital video recorder;
said means for interrupting enable a user to pass over a commercial portion of said primary content produced by a content producer; and
said ancillary content is produced by either the content producer or an another content producer.
